(19) United States
(12) Patent Application Publication
(10) Pub. No.: US 2010/0318542 A1
(43) Pub. Date: Dec. 16, 2010

(54) METHOD AND APPARATUS FOR CLASSIFYING CONTENT

(75) Inventor: Paul C. Davis, Arlington Heights, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/484,471

(22) Filed: Jun. 15, 2009

(51) Int. Cl. G06F 17/30

(52) U.S. Cl. 707/759; 707/791; 707/802; 707/803; 707/957; 707/713; 707/738

(57) ABSTRACT

Natural-language words are associated with content. The natural-language words are identified from, for example, metadata and/or the actual content itself. Each word identified for the content is associated with the identified genre of the content (from, for example, its tagged metadata). A database is then maintained having a number of occurrences of each word from the multiple content items for each genre. Once the word/genre database is created, subgenres for a particular program/content can be created by once again using statistics from the words identified for that program to rank the most appropriate genres for the words and produce sets of the highest ranked genres.

### FIELD OF THE INVENTION

The present invention relates generally to classifying content and in particular, to a method and apparatus for classifying electronic content.

### BACKGROUND OF THE INVENTION

Oftentimes electronic content is classified so that a user may determine the type of content. For example, an electronic program guide (EPG) may display a particular program as being classified as a “comedy”. In addition, recommender systems and search engines may exploit content classification in order to match, find, and/or rank relevant content.

In the domain of television programming, where content is often accompanied by EPG metadata, content has often been classified by associations between various aspects of this metadata. One problem with such classification efforts is that textual descriptions of content in metadata are often very sparse yet highly dimensional, and therefore often are of little utility for classifying content. A related problem is that one of the most highly informative aspects of metadata, those which indicate the genre or category, are typically underutilized with respect to other metadata and content features. A third problem is that there is an ever increasing amount of content with little or no metadata, making the classification task more difficult.

There exist a number of previous efforts to resolve these problems in personalization and recommender systems in the prior art, however, none successfully infer an arbitrary amount of additional relationships between metadata by making use of linguistic content. For example, in U.S. Pat. No. 7,243,085 B2, “Hybrid personalization architecture” a probabilistic network is constructed from metadata and linguistic content where nodes in the network are viewed as concepts in an ontology and the edges connecting the nodes are associated with weights indicating the strength of the relationship between the concepts. These edges and weights are in part derived from the relationship between metadata and linguistic content. This approach falls short of solving the general problem of inferring an arbitrary amount of relationships between aspects of metadata, however, because it only allows for pairwise relationships between the concepts. The method identified in the present invention solves this and the three aforementioned problems. Therefore a need exists for a method and apparatus for classifying content that more appropriately utilizes content metadata or aspects of the content itself and provides a more accurate classification of the content.

### BRIEF DESCRIPTION OF THE DRAWINGS

FIG. 1 is a block diagram showing an apparatus used for text entry and classification.

FIG. 2 illustrates a database of words and their associated genre.

FIG. 3 is a flow chart showing the operation of the apparatus of FIG. 1 during the initial metadata or content processing phase which populates a database.

FIG. 4 is a flow chart showing the operation of the apparatus of FIG. 1 during the classification of content.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method and apparatus for classifying content is provided herein. During operation the natural language existing in metadata and/or in the program content itself is used to infer finer-grained distinctions for television program genres/categories. In accomplishing this task, the occurrences of natural language words are tracked with category labels such as genre (supplied by and/or inferred from the metadata or natural language existing in the content), and then used to produce fine-grained relationships between the genres, to a particular level of precision.

More particularly, natural-language words are associated with each program. The natural-language words are identified from, for example, metadata and/or the actual program itself. Each word identified for a program is associated with the identified genre of the program (from, for example, its tagged metadata). A database is then maintained having a number of occurrences of each word from the multiple programs for each genre. Once the word/genre database is created, subgenres for a particular program can be created by once again using the words identified for that program to rank the most appropriate genres for the words (i.e., the genres having the most occurrences for that word). A program here can be understood to mean any type of content which may contain or be associated with (i.e., via metadata) natural language, such as a television program, movie, video, etc.

The above technique can also be extended such that the words used for ranking the genres are a subset of the words identified for the program, based, for example, on the importance of such words in the program. Similarly, the technique can be extended such that sets of words, rather than single words, are use for the ranking. Further, the technique can be extended such that the items used for the ranking need not be the words from the program, but rather other words or representations that are associated with the words or sets of words from the program. Similarly, the technique can be extended such that criteria other than word frequency are used to rank the most appropriate genre. For example, the ranking criteria could be the probability of the word, the deviation from an expected probability, or the term frequency-inverse document frequency weighting, where different items can alternatively be used as for the basis of document frequency such as programs or genres themselves, etc. Such criteria can be derived with data from the collection of programs and/or from sources external to the programs, such as corpora from related domains. For example, statistics regarding word frequency, genre frequency, and co-occurrence can be derived from additional corpora (e.g., the internet), to aide in the determination of probabilities to be used in the selection of words related to a particular program.

The above technique uses both the textual content in the metadata and/or the linguistic content in the programs themselves to make finer-grained distinctions of program categories/genre. This improved ranking allows for a number of improvements to applications such as better relevancy ranking for search, improved clustering, and better recommendations.

The present invention encompasses a method for classifying content. The method comprises the steps of identifying a particular program in order to determine a genre or category for the program, creating a list of words associated with the program, and accessing a database comprising stored words and their associated genres or categories for each word. The genre or category is then determined for the program based on a comparison of the list of words with the stored words and their associated genres or categories.

The present invention additionally encompasses a method for classifying content. The method comprises the steps of:

creating a database by:
creating a list of words associated with a first program;
determining a genre of the first program;
appending the list of words and their genre to a database;

determining a genre or category for a second program by:
identifying the second program in order to determine a genre or category for the program;
creating a second list of words associated with the second program
determining the genre of the second program by accessing the database and determining genres associated with words from the second list of words.

The present invention additionally encompasses an apparatus comprising a database comprising stored words and their associated genres or categories for each word, and logic circuitry identifying a particular program in order to determine a genre or category for the program, creating a list of words associated with the program, accessing the database, and determining the genre or category for the program based on a comparison of the list of words with the stored words and their associated genres or categories.

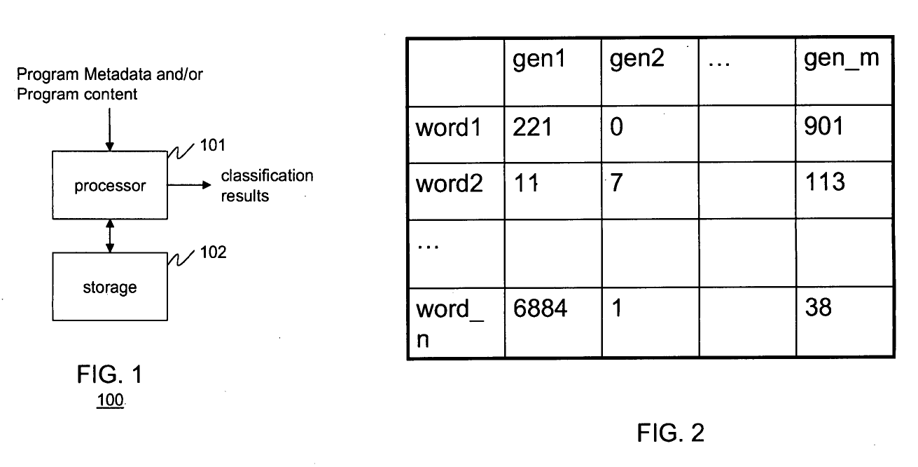

Turning now to the drawings, where like numerals designate like components, FIG. 1 is a block diagram showing apparatus 100 used for classifying content. Apparatus 100 may be incorporated into any electronic device that is capable of classifying content. Such devices include, but are not limited to TV set-top boxes, cellular telephones, head end equipment, Personal Digital Assistants (PDAs), personal computers, . . . , etc.

As shown, apparatus 100 comprises an electronic processor 101 and storage 102. Processor 101 comprises logic circuitry such as a digital signal processor (DSP), general purpose microprocessor, a programmable logic device, or application specific integrated circuit (ASIC) and is utilized to create the contents of storage 102 and to classify content. Storage 102 comprises standard random access memory and is used to store information that can be textually searched.

During operation of apparatus 100, program metadata and/or program content is received by processor 101. The metadata and/or program content may be from an electronic program guide, from a textual transcript of the program (e.g., via closed-captioned or automatic speech recognition of natural language components of the program), from an online content or metadata service, and/or any other means for providing content to processor 101. In response, processor 101 will populate storage 102 and output classification results/genres for a particular program. As discussed above, processor 101 will create a database having a number of occurrences of each word from the multiple programs for each genre. Once the word/genre database is created, sub-genres for a particular program can be determined by once again using (a subset of) the words identified for that program to rank the most appropriate genres for the words (i.e., the genres having the most occurrences for that word or genres which are most probable as determined by criteria other than frequency).

### Creation of a Database:

As discussed above, a database is created by processor 101 and stored in storage 102. In creating the database, processor 101 utilizes multiple programs and determines their identified genre (e.g., from metadata about each program, or via processing of the natural language taken directly from the content of the program to determine top-level genres for the content when there is no metadata supplied). A list of words is then created for each program by processor 101. As discussed above, the list of words for each program is created by words that are identified from, for example, metadata and/or the actual program itself. More particularly, the list of words (or word sequences) can be optionally preprocessed and normalized using various established techniques from the field of natural language processing, which are helpful in reducing the number of items to consider (thus reducing the dimensionality). These techniques include the removal of certain less informative high-frequency stop words (e.g., “the”, “it); the removal of certain punctuation, dates, symbols, numbers, etc. (depending on the type of application); stemming (the process of reducing various forms of a word to a base or root form); normalizing the case, segmentation, and so on. In addition, the preprocessed and normalized words can be optionally further reduced to a subset of words (or word sequences) which are most representative of the program. This identification of the most representative words can again be done by any of various well-known techniques from the field of natural language processing, such as via keyterm extraction.

Once processor 101 has created a normalized list of words for a given program, processor 101 then counts the occurrence of each word with the program's identified genre and creates, or adds information to a database containing the words/genre and the number of occurrences for each word for the particular genre. This database is illustrated in FIG. 2.

As shown in FIG. 2, the database comprises a table having genre across the x-dimension and different words across the y-dimension. The table is filled with the number of occurrences for each word/genre combination. Thus, for example, “word2” was identified by processor 101 as a word associated 11 times with genre_1, and 7 times for genre_2. So, for example, if “word2” was equal to “baseball” and genre_1 was “outdoors” and “genre_2” was “sporting events”, then the term “baseball” would have been identified 11 times as belonging to a program having a genre of “outdoors” and 7 times as belonging to a program identified as having a genre of “sporting events”.

In order to account for common words, the database may be adjusted for frequency of usage for particular words. The adjustment may be based on (deviations from) expectations of counts as predicted by models of the domain and/or the language in general, etc.

It should be noted that the database held in storage 102 comprises many words from many different programs. The combined results of all analyzed programs are then used to further classify content (described below).

### Classification of Content:

Once the database comprising the word/genre matrix is created, it can then be used to better categorize content such as television shows, internet video, . . . , etc. In order to do so, the content is analyzed by processor 101 to determine a list of words describing the content (as described above). Once a list of words describing the content is determined, the database in storage 102 is accessed by processor 101 in order to determine the different genres associated with each word. For example, referring to FIG. 2, “baseball” would have been identified 11 times as belonging to a program having a genre of “outdoors”. The word/genre combinations having the highest number of occurrences (or ranked highest by a different criteria, as described earlier) are then used to determine a listing of genres that identify the program. These additional genre listings can then be used as additional, highly-informative features for classification of programs.

The amount of genres produced may vary. For example, for a given set of words, and a set of, 50 genres, g1, g2, . . . g50, only the top-two ranked genres may be used (e.g., g17 and g31). Alternatively the genre names can be combined together to produce a single, new genre g17_g31 (e.g., outdoors_sporting_events).

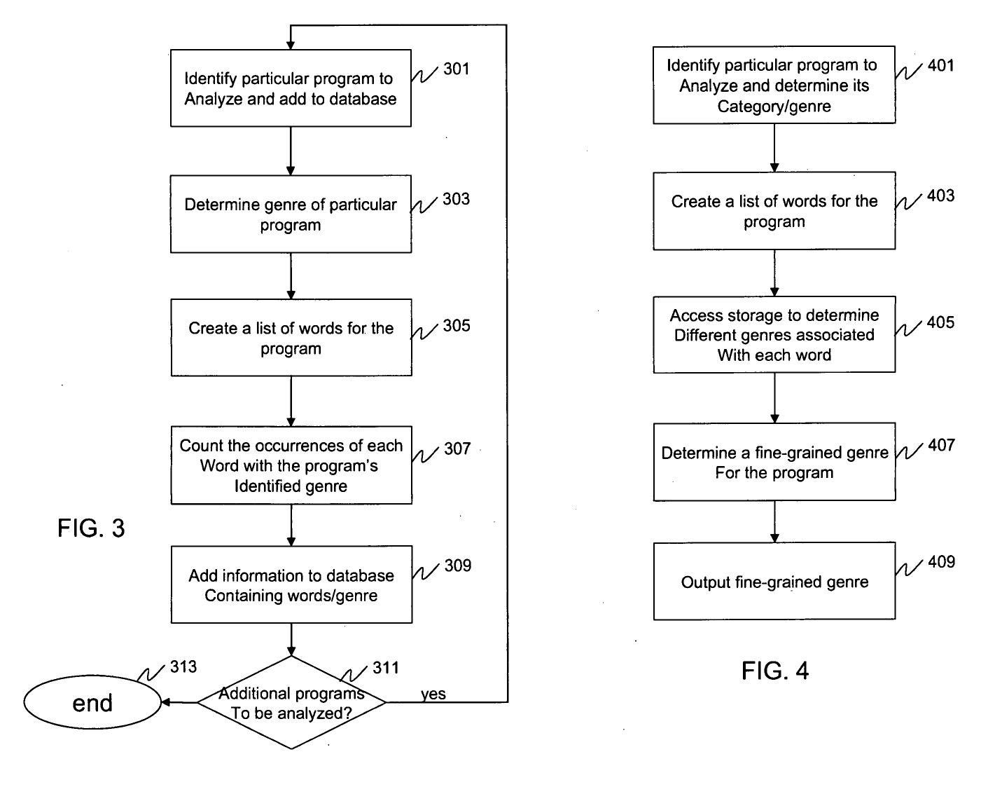

FIG. 3 is a flow chart showing the operation of the apparatus of FIG. 1 during the creation of a database. The logic flow begins at step 301 where a particular program is identified by processor 101 to be analyzed and the results added to a database contained in storage 102. At step 303 the genre is determined for the particular program by processor 101. As discussed, this genre is a simple genre, and may be provided by an EPG. The logic flow continues to step 305 where processor 101 creates a list of words for the program. As discussed above, the creation of the list may include various preprocessing steps for normalization and the removal of less informative words as discussed above.

Once processor 101 has created a normalized list of words for a given program, processor 101 then counts the occurrence of each word with the program's identified genre (step 307) and creates, or adds information to a database containing the words/genre and the number of occurrences for each word for the particular genre (step 309). Finally, at step 311, processor 101 determines if any other programs need to be analyzed and added to the database, and if so, the logic flow returns to step 301, otherwise the logic flow ends at step 313.

The above technique creates a database that can then be utilized by processor 101 to make finer-grained distinctions of program categories/genre. This improved distinction in categories/genres allows for a number of improvements to applications such as better relevancy ranking for search, improved clustering, and better recommendations.

FIG. 4 is a flow chart showing the operation of the apparatus of FIG. 1 during the classification of content. The logic flow begins at step 401 where a particular program is identified by processor 101 to be analyzed to determine its finer-grained genre or category. As discussed, the particular program comprises a television show, a video, internet content, an electronic document, or any content for which there exists metadata or a natural language representation of the content.

At step 403 processor 101 creates a list of words most representative of the program. This list may be from metadata associated with the program, or from the actual content of the program itself. As discussed above, the creation of the list may include various preprocessing steps for normalization and the removal of less informative words as discussed above.

Once processor 101 has created a list of words for a given program, processor 101 then accesses storage 102 to determine the different genres associated with each word (step 405). As discussed above, storage 102 comprises a database comprising stored words from multiple programs and their associated genres or categories for each word. At step 407 processor 101 then determines a fine-grained genre or category for the program based on a comparison of the list of words with the stored words and their associated genres or categories. The finer-grained genres or categories may then be output by processor 101.

As discussed, the word/genre combinations having the highest number of occurrences (or ranked highest by a different criteria, as described earlier) are used by processor to determine a listing of genres that identify the program. The determined genre(s) is then output from processor 101, and may be used for a number of improvements to applications such as better relevancy ranking for search, improved clustering, and better recommendations. The amount of genres produced may vary. For example, for a given set of words, and a set of, 50 genres, g1, g2, . . . g50, only the top-two ranked genres may be used (e.g., g17 and g31). Alternatively the genre names can be combined together to produce a single, new genre g17_g31 (e.g., outdoors_sporting_events).

It should be noted that in the flow chart of FIG. 4, once the finer-graned genre(s) have been determined, the programs gross genre (as determined from e.g., metadata) can be determined and appended to the database.

While the invention has been particularly shown and described with reference to a particular embodiment, it will be understood by those skilled in the art that various changes in form and details may be made therein without departing from the spirit and scope of the invention. For example, the ‘words’ in the matrix can be extended to any text processing unit or combination thereof, such as sequences, ngrams, POS tags, etc., as well as mapped to smaller or constrained units (e.g., synonyms, etc.), or mapped to units of meaning (e.g., ontologies, etc.) so that generalization can be increased. Additionally, the genre and subgenre relationships learned on content with metadata can be used to infer likely categories (genres and subgenres). Additionally, additional non-linguistic metadata and non-metadata features (e.g., show running time) can be used in conjunction with these genre related features to categorize, cluster, and rank programs. Similarly, the domain of content to be classified can be extended from television or video to any sort of content for which there may be metadata or a natural language representation of the content (e.g., internet content, electronic documents, etc.). Also, the criteria used for determining ranking can be something different from or in addition to simple word frequency, for example, it can take into account the expected frequency of the given word or term in the given domain, based on statistics, the programs themselves, or from other sources. It is intended that such changes come within the scope of the following claims:

1. A method for classifying content, the method comprising the steps of:
identifying a particular program in order to determine a genre or category for the program;
creating a list of words associated with the program;
accessing a database comprising stored words and their associated genres or categories for each word; and
determining the genre or category for the program based on a comparison of the list of words with the stored words and their associated genres or categories.

2. The method of claim 1 wherein the database comprises stored words from multiple programs and their associated genres.

3. The method of claim 1 wherein the step of creating the list of words associated with the program comprises the step of identifying the words from metadata associated with the program.

4. The method of claim 1 wherein the step of creating the list of words associated with the program comprises the step of identifying the words directly from the content of the program.

5. The method of claim 1 further comprising the steps of:
determining a gross genre of the program from metadata; and
appending the list of words associated with the program and the gross genre to the database.

6. The method of claim 1 wherein the particular program comprises a television show, a video, internet content, an electronic document, or any content for which there exists metadata or a natural language representation of the content.

7. The method of claim 1 wherein the step of determining the genre or category for the program comprises the steps of:
determining words from the list of words that are most representative of the program;
determining the genre from the words that are most representative of the program.

8. The method of claim 1 wherein the step of determining the genre comprises the step of combining genre names together to form a single genre.

9. The method of claim 1 wherein the step of determining the genre or category for the program is additionally based on data obtained from a source outside the database.

10. A method for classifying content, the method comprising the steps of:
creating a database by:
creating a list of words associated with a first program;
determining a genre of the first program;
appending the list of words and their genre to a database;
determining a genre or category for a second program by:
identifying the second program in order to determine a genre or category for the program;
creating a second list of words associated with the second program
determining the genre of the second program by accessing the database and determining genres associated with words from the second list of words.

11. The method of claim 10 wherein the database comprises stored words from multiple programs and their associated genres.

12. The method of claim 10 wherein the step of creating the list of words associated with the programs comprises the step of identifying the words from metadata associated with the programs.

13. The method of claim 10 wherein the step of creating the list of words associated with the programs comprises the step of identifying the words directly from the content of the programs.

14. The method of claim 10 wherein the programs comprise a television show, a video, internet content, an electronic document, or any content for which there exists metadata or a natural language representation of the content.

15. The method of claim 10 wherein the step of determining the genre comprises the steps of:
determining words from the second list of words that are most representative of the program;
determining the genre from the words that are most representative of the program.

16. The method of claim 15 wherein the step of determining the genre comprises the step of combining genre names together to form a single genre.

17. The method of claim 10 further comprising the step of:
outputting the genre of the second program.

18. An apparatus comprising:
a database comprising stored words and their associated genres or categories for each word;
logic circuitry identifying a particular program in order to determine a genre or category for the program, creating a list of words associated with the program, accessing the database, and determining the genre or category for the program based on a comparison of the list of words with the stored words and their associated genres or categories.

19. The apparatus of claim 18 wherein the database comprises stored words from multiple programs and their associated genres.

20. The apparatus of claim 18 wherein the list of words associated with the program is created by identifying the words from metadata associated with the program.
